(19) United States
(12) Patent Application Publication
(10) Pub. No.: US 2016/0125780 A1
(43) Pub. Date: May 5, 2016

(54) SENSORS EMPLOYING CONTROL SYSTEMS DETERMINING LOCATIONS OF MOVABLE DROPLETS WITHIN PASSAGEWAYS, AND RELATED METHODS

(71) Applicant: Applied Materials, Inc., Santa Clara, CA (US)

(72) Inventors: Robert Jan VISSER, Menlo Park, CA (US); Michel Anthony ROSA, Austin, TX (US); Ananth DODABALAPUR, Austin, TX (US)

(21) Appl. No.: 14/883,853

(22) Filed: Oct. 15, 2015

Related U.S. Application Data
(60) Provisional application No. 62/075,034, filed on Nov. 4, 2014.

(51) Int. Cl. G09G 3/20; G01C 9/10; G01P 15/125

(52) U.S. Cl. CPC G09G 3/20; G01P 15/125; G01C 9/10; G09G 2340/0492

(57) ABSTRACT

Sensors employing control systems determining locations of movable droplets within passageways, and related methods are disclosed. A sensor includes a movable droplet within a passageway supported on a substrate. The droplet may move to and from a quiescent point in the passageway which is at least partially formed by a hydrophobic layer. By including a hydrophobic layer having a hydrophobicity characteristic which decreases according to distance from the quiescent point, the droplet may move to a displacement position outside of the quiescent point in response to an external force. A control system of the sensor determines an acceleration and/or angular position of the sensor based on the displacement position. In this manner, a low cost sensor may be fabricated with without expensive nanostructures.

### CROSS-REFERENCE TO RELATED APPLICATIONS

This application claims benefit of U.S. Provisional Patent Application Ser. No. 62/075,034, filed Nov. 4, 2014, which is herein incorporated by reference.

### BACKGROUND

1. Field

Embodiments of the present disclosure generally relate to sensors, and in particular to microfluidic devices to determine acceleration and/or angular tilt position.

2. Description of the Related Art

With the development of electronic devices with additional computing power, there is an increasing need for devices to improve user interfaces which user's experience. User interfaces can improve by better gaining a situational awareness and changing the way that data can be conveyed or received depending on the situation. For example, when a computer display is rotated, for example ninety degrees or 180 degrees, the sensor in the computer display can sense the new angular position and change the orientation of the information displayed on the monitor consistent with the new angular position. Likewise, mobile devices may use sensors, for example, as accelerometers to serve a pedometer to determine walking speed, as a user interface for video games, and as a shock sensor to notify the user of the risk that a certain extreme activity may damage the device. As costs of electronic devices decrease, there is also a need for less-expensive sensors to be used with electronic devices. Lower cost sensors measuring acceleration and/or angular positions of electronic devices are needed which may be used to improve user interfaces and do not rely on expensive nanotechnology technology.

### SUMMARY

Embodiments disclosed herein include sensors employing control systems determining locations of movable droplets within passageways, and related methods. A sensor includes a movable droplet within a passageway supported on a substrate. The droplet may move to and from a quiescent point in the passageway which is at least partially formed by a hydrophobic layer. By including a hydrophobic layer having a hydrophobicity characteristic which decreases according to distance from the quiescent point, the droplet may move to a displacement position outside of the quiescent point in response to an external force. A control system of the sensor determines an acceleration and/or angular position of the sensor based on the displacement position. In this manner, a low cost sensor may be fabricated with without expensive nanostructures.

In one embodiment, a sensor is disclosed. The sensor includes a substrate having a plurality of first electrodes arranged along a longitudinal axis of a passageway. The sensor includes a hydrophobic layer forming at least a portion of the passageway. The sensor also includes a second electrode supported by the substrate, wherein the passageway is disposed between the second electrode and the plurality of first electrodes. The sensor also includes a droplet disposed within the passageway. The droplet moves to a displacement position within the passageway in response to an external force. The sensor also including a control system electrically coupled to the plurality of first electrodes and the second electrode, and the control system is configured to determine positional information of the droplet at the displacement position. In this manner, a low cost sensor may be provided wherein additional manufacturing expense of forming micro-electro-mechanical systems (MEMS) parts is avoided.

In another embodiment a method is disclosed. The method includes moving a droplet to a quiescent point within a passageway of the sensor using an electrowetting force as directed by a control system of the sensor. The method also includes moving, in response to an external force, the droplet to a displacement position within the passageway while the droplet remains in contact with a hydrophobic layer. The method also includes determining, using the control system, positional information of the droplet at the displacement position based on electrical signals from a plurality of first electrodes disposed along the passageway and a second electrode. In this manner, the positional information may be used to determine either acceleration or angular position.

In another embodiment, an accelerometer is disclosed. The accelerometer includes a substrate including a plurality of first electrodes arranged sequentially along a longitudinal axis extending from a first end to a second end opposite the first end, wherein centers of adjacent ones of the plurality of first electrodes along the longitudinal axes are separated by a distance in a range from 150 microns to 1.2 millimeters. The accelerometer also includes a hydrophobic layer forming at least a portion of the passageway. The accelerometer also includes a second electrode supported by the substrate, wherein the passageway is disposed between the second electrode and the plurality of first electrodes. The accelerometer also includes a droplet disposed within the passageway, wherein the droplet moves within the passageway to a displacement position in response to an external force. The accelerometer also includes control system electrically coupled to the plurality of first electrodes and the second electrode, and the control system is configured to apply an electric field between the plurality of first electrodes and the second electrode to move the droplet to a quiescent point within the passageway using an electrowetting force at the beginning of each of a plurality of cycles, the control system is further configured to determine positional information of the droplet at the displacement position during each of the plurality of cycles and to determine an acceleration of the sensor due to the external force for each of the plurality of cycles. In this manner, the acceleration can be determined by the accelerometer without need for expensive movable nanostructures.

Additional features and advantages will be set forth in the detailed description which follows, and in part will be readily apparent to those skilled in the art from that description or recognized by practicing the embodiments as described herein, including the detailed description that follows, the claims, as well as the appended drawings.

It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIG. 1A is a top perspective view of an exemplary electronic device having an exemplary sensor which includes a control system and at least one substrate having passageways, wherein the control system determines locations of droplets which are movable in response to external forces to determine at least one of tilt and/or acceleration from the positional response of the droplets to the external forces;

FIG. 1B is a side sectional schematic view of an exemplary droplet within a passageway of the sensor of FIG. 1A, wherein the droplet is disposed at a quiescent point and the control system is configured to determine positional information of the droplet based on electrical signals from a plurality of first electrodes and a second electrode;

FIG. 1C is a side sectional schematic view of the droplet within the passageway of FIG. 1B, wherein the droplet has moved from the quiescent point in response to an external force;

FIG. 1D is a side sectional schematic view of the droplet within the passageway of FIG. 1C, depicting the droplet returned to the quiescent point by the control system using an electrowetting force;

FIG. 2A is a top perspective partial sectional view of one the at least one substrate having a plurality of passageways, the control system, and the power supply of the sensor of FIG. 1A;

FIG. 2B is a top view of one the at least one substrate of FIG. 2A prior to forming a hydrophobic layer therein illustrating an array of first electrodes whose voltage potentials can be applied by instructions of the control system;

FIG. 3A is a side sectional schematic view of a droplet supported by a hydrophobic layer depicting before and after shapes of the droplet of FIG. 1B as the first electrodes and second electrode apply an electric field to the droplet;

FIG. 3B is a side sectional schematic view of the droplet of FIG. 1B being propelled along the hydrophobic layer of the sensor of FIG. 1A by the electrowetting force resulting from an asymmetric electric field applied to the droplet by the plurality of first electrodes and the second electrode;

FIG. 3C is a chart depicting a hydrophobicity characteristic of the hydrophobic layer relative to a quiescent point of the sensor depicted in FIG. 3B;

FIG. 4 is a flowchart of an exemplary process for operating the sensor of FIG. 1A;

FIG. 5A is a side sectional view of an exemplary passageway of another embodiment of a sensor illustrating a droplet disposed at a quiescent point and a control system configured to determine positional information of the droplet based on electrical signals from the plurality of first electrodes and the second electrode as a gravitational force is applied to the droplet;

FIG. 5B is a side sectional view of the droplet with the sensor of FIG. 5A in a tilted position to create a component of the gravitational force applied to the droplet and parallel to the hydrophobic surface of the first hydrophobic layer;

FIG. 5C is a side sectional view of the droplet and the sensor of FIG. 5B depicting the droplet in a static position at the displacement position as the component of the gravitational force parallel to the hydrophobic surface is fully opposed by a wetting force from the sensor; and

FIG. 5D is a side sectional view of the droplet and the sensor of FIG. 5C depicting returning the droplet to the quiescent point, by using the electrowetting force resulting from an asymmetric electric field applied to the droplet between predetermined ones of the plurality of first electrodes and the second electrode.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Reference will now be made in detail to the embodiments, examples of which are illustrated in the accompanying drawings, in which some, but not all embodiments are shown. Indeed, the concepts may be embodied in many different forms and should not be construed as limiting herein. Whenever possible, like reference numbers will be used to refer to like components or parts.

Embodiments disclosed herein include sensors employing control systems determining locations of movable droplets within passageways, and related methods. A sensor includes a movable droplet within a passageway supported on a substrate. The droplet may move to and from a quiescent point in the passageway which is at least partially formed by a hydrophobic layer. By including a hydrophobic layer having a hydrophobicity characteristic which decreases according to distance from the quiescent point, the droplet may move to a displacement position outside of the quiescent point in response to an external force. A control system of the sensor determines an acceleration and/or angular position of the sensor based on the displacement position. In this manner, a low cost sensor may be fabricated with without expensive nanostructures.

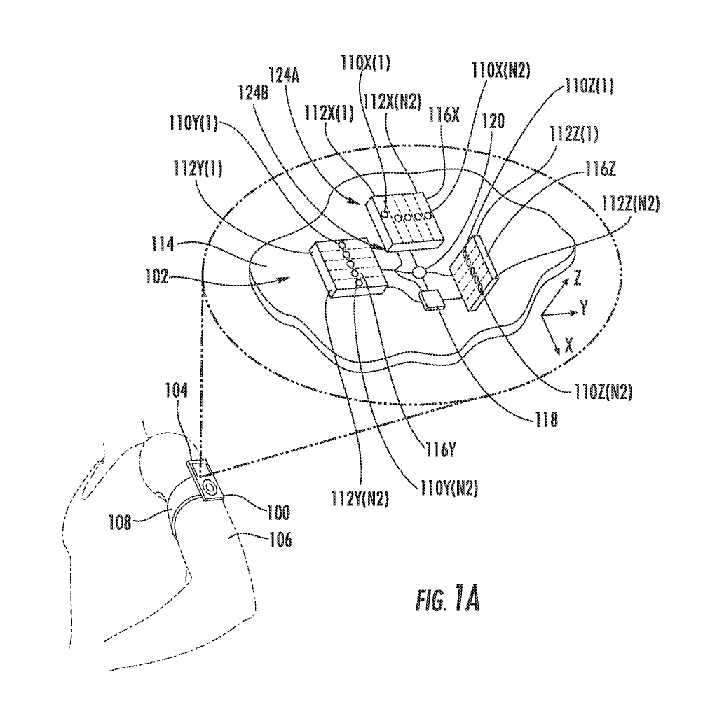

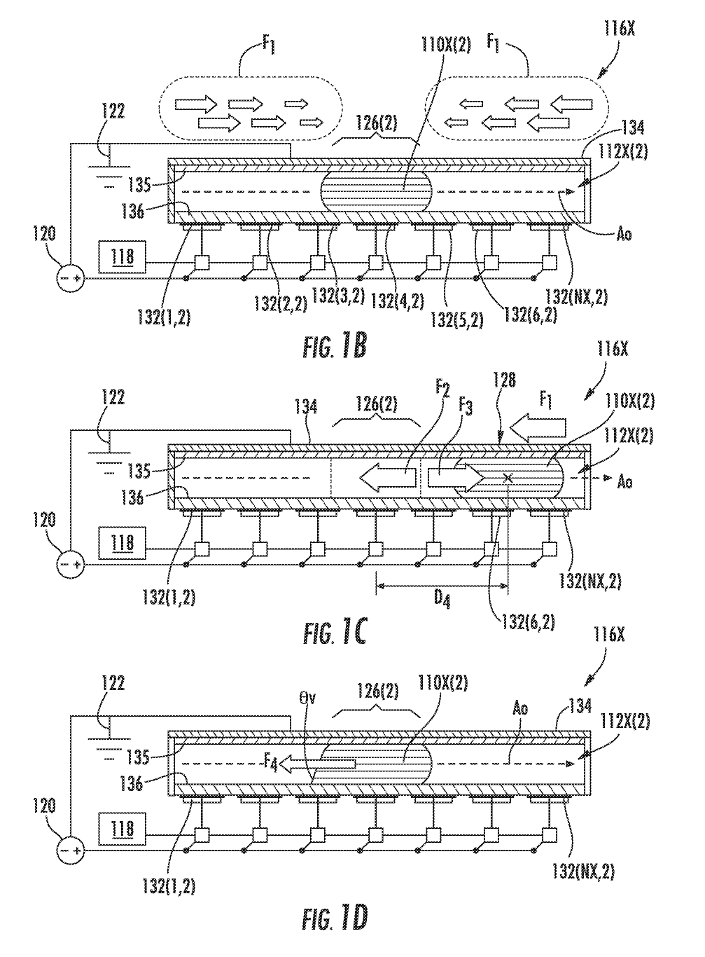

In this regard, FIG. 1A is a top perspective view of an exemplary electronic device 100 having an exemplary sensor 102 attached thereto. The sensor 102 determines acceleration of the electronic device 100 resulting from an external force F2 applied to the sensor 102. In this example, the electronic device 100 may be a mobile device with an informational display 104, and the electronic device 100 may be utilized in applications where changing movements (or accelerations) of the electronic device 100 are to be determined in response to the external force F2. Examples of the external force F2 may include gravitational forces, acceleration, and/or deceleration forces. In the exemplary embodiment depicted in FIG. 1A, the electronic device 100 is supported by a user 106 through an armband 108 which may impart the external force F2 to the electronic device 100 and the sensor 102 attached thereto. As the external force F2 is applied to the electronic device 100, droplets 110X(1)-110X(N2) of the sensor 102 move in response within the passageways 112X(1)-112X(N2) which have predetermined directional orientations relative to each other. The changed positional information of the droplets 110X(1)-110X(N2) in response to the applied force F2 is used by the sensor 102 to determine the acceleration of the sensor 102 parallel to the longitudinal axes A0 of the passageways 112X(1)-112X(N2), for example, in the X-direction.

The sensor 102 is attached through a mounting interface 114. Components of the sensor 102 may be supported by the mounting interface 114 of the electronic device 100. The sensor 102 includes at least one subassembly 116X and a control system 118. Other subassemblies 116Y, 116Z may be used to determine acceleration in different directions, for example, in the Y-direction and Z-direction. The sensor 102 may be electrically coupled to the mounting interface 114 which may provide an electrical power supply 120 and an electrical ground 122, or in another example, the electrical power supply 120, and the electrical ground 122 may be part of the sensor 102 and electrically uncoupled from the mounting interface 114 of the electronic device 100. In this manner, the sensor 102 receives electrical power.

The at least one subassembly 116X determined the acceleration applied to the sensor 102 by the external force F2. In the embodiment shown in FIG. 1A, the subassemblies 116X-116Z may be used to provide measurable responses to changes to angular orientations of the sensor 102 relative to respective ones of the X, Y, Z axes and/or determine accelerations (or decelerations) applied to the sensor 102 in respective ones of the respective X, Y, Z axes. In particular, the subassembly 116X may be configured to provide measurable responses to components of acceleration along the X-axis. The subassembly 116Y may be configured to provide measurable responses to components of acceleration along the Y-axis. The subassembly 116Z may be configured to provide measurable responses to components of acceleration along the Z-axis. In this manner, the sensor 102 can be used to provide measurable responses in multiple axes X, Y, Z for determination of the acceleration of the sensor 102 to the external force F2 defined in three-dimensions.

For purposes of illustration, the subassembly 116X is now introduced and a similar discussion is applicable to subassemblies 116Y, 116Z. The subassembly 116X includes the one or more passageways 112X(1)-112X(N2) which may extend from a first end 124A to a second end 124B opposite of the first end 124A of the subassembly 116X along respective longitudinal axes A₀ orientated along the X-axis. Each of the passageways 112X(1)-112X(N2) have the respective droplets 110X(1)-110X(N2) disposed therein. The droplets 110X(1)-110X(N2) may move along the longitudinal axes A0 of the respective passageways 112X(1)-112X(N2) in response to the acceleration resulting from the external force F2 applied to the sensor 102. The control system 118 of the sensor 102 determines positional information of one of more of the droplets 110X(1)-110X(N2) in response to the external force F2. The control system 118 may then use this positional information to determine the acceleration along the X-direction for example using a lookup table or algorithmic approaches.

The subassemblies 116Y, 116Z include the passageways 112Y(1)-112Y(N2), 112Z(1)-112Z(N2), respectively orientated along the Y-axis and the Z-axis. The passageways 112X(1)-112X(N2) of the subassembly 116X are depicted as being parallel for simplicity and efficiency of discussion, but it is recognized that the respective passageways of the subassemblies 116X-116Y may be incorporated on a single subassembly (not shown) to provide the same functionality as the subassemblies 116X-116Z provided separately. The features discusses in subassembly 116X are similar to those in the subassemblies 116Y, 116Z, except for directional orientations relative to the X, Y, and Z axes.

FIG. 1B is a side sectional schematic view of the droplet 110X(2) disposed at a quiescent point 126(2) within the passageway 112X(2) of the subassembly 116X. Fundamentals of the sensor 102 may be discussed in terms of interactions between the control system 118 and the droplet 110X(2) within the passageway 112X(2) of the subassembly 116X. The quiescent point 126(2) is a location within the passageway 112X(2). Movement of the droplet 110X(2) along the longitudinal axis A0 of the passageway 112X(2) to a displacement position 128 in response to a later occurrence of the external force F2 (FIG. 1C) can be determined by the control system 118. The control system 118 determines acceleration of the sensor 102 based on the displacement position 128.

With continuous reference to FIG. 1B, the subassembly 116X includes electrodes for monitoring the positional information of the droplet 110X(2) and to return the droplet 110X(2) to the quiescent point 126(2) to prepare for a subsequent determination of acceleration. In this regard, the passageway 112X(2) and the droplet 110X(2) therein are disposed between a plurality of first electrodes 132(1,2)-132(NX,2) and a second electrode 134. The control system 118 may be electrically connected to both the power supply 120 and the electrical ground 122. The first electrodes 132(1,2)-132(NX,2) are disposed along the passageway 112(2), for example, in a sequential pattern for efficiency of movement for the droplet 110X(2). The second electrode 134 extends along the length of the passageway 112X(2) and may be the same voltage potential, for example electrical ground. Capacitance changes between the second electrode 134 and the various ones of the first electrodes 132(1,2)-132(NX,2) nearest the droplet 110X(2) based on a location of the droplet 110(2). The control system 118 determines the location of the droplet 110X(2) based on location information of the various ones of the first electrodes 132(1,2)-132(NX,2) based on the changed capacitance. In the example depicted in FIG. 1B, the control system 118 determines that the changed capacitance occurs between first electrode 132(4,2) and the second electrode 134. In this manner the control system 118 may confirm that the droplet 110X(2) is at the quiescent point 126(2) and is available to determine a subsequent acceleration by receiving the external force F2.

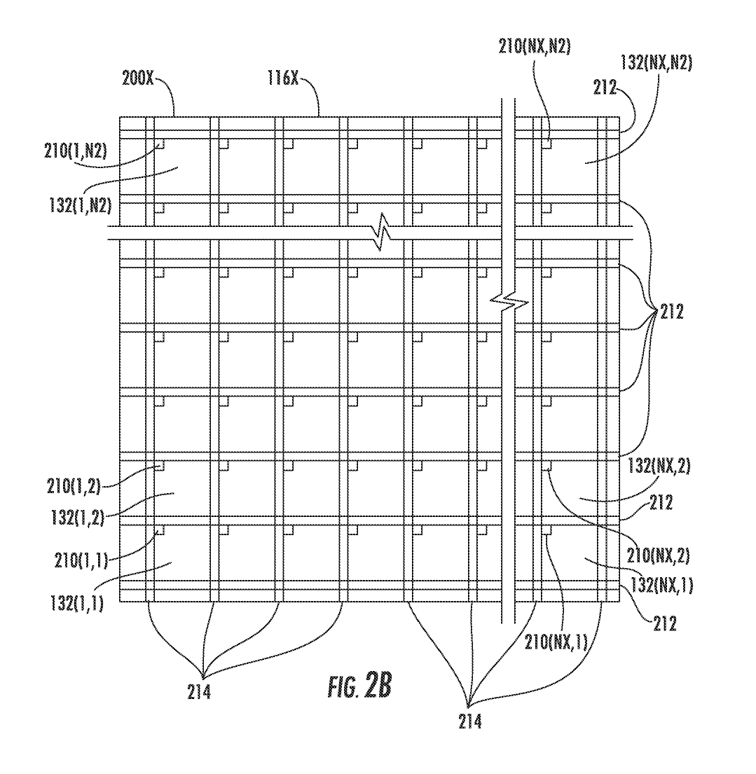

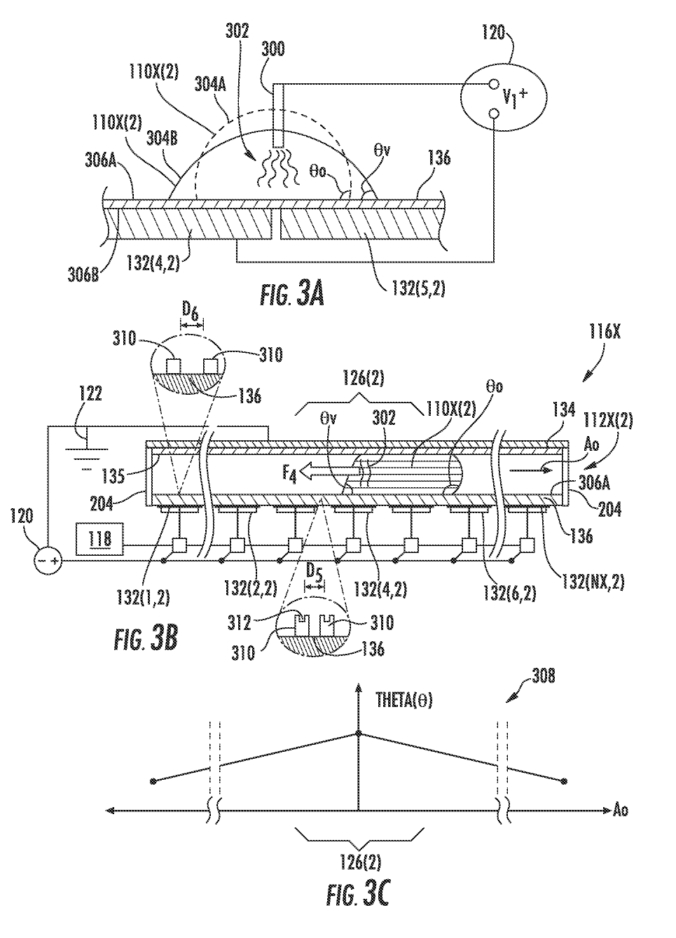

FIG. 1C is a side sectional schematic view of the droplet 110X(2) within the passageway 112X(2) of FIG. 1B, wherein the droplet 110X(2) has moved from the quiescent point 126(2) to a displacement position 128 in response to the external force F2 applied to the sensor 102. For example, the external force F2 may be an acceleration force transferred by the armband 108 (FIG. 1A) as the user 106 is engaged in an activity. As the external force F2 is applied to the sensor 102, at least a component of the external force F2 directed along the longitudinal axis A0 of the passageway 112X(2) causes the droplet 110X(2) to move from the quiescent point 126(2) to the displacement position 128. In this regard, the droplet 110X(2) moves along the passageway 112X(2) in the opposite direction of the component of the external force F2 and parallel to the longitudinal axis A0 due to an inertia force F3 applied to the droplet 110X(2) equal to the external force F2. A wetting force F1 from a first hydrophobic layer 136 in contact with the droplet 110X(2) resists movement of the droplet 110X(2) away from the quiescent point 126(2). The first hydrophobic layer 136 provides increasing amounts of the wetting force F1 away from the quiescent point 126(2) and limits the movement of the droplet 110X(2) to the displacement position 128 located a distance D4 from the quiescent point 126(2) as the wetting force F1 becomes sufficient enough to stop movement of the droplet 110X(2) within the passageway 112X(2). The wetting force F1 may be predetermined along the central axis A0 of the passageway 112X(2) by establishing a hydrophobicity characteristic 308 (FIG. 3C) of the first hydrophobic layer 136 which changes along the longitudinal axis A0 of the passageway 112X(2) as is discussed later in this disclosure. In this manner, the distance D4 may be associated with strength of the external force F2 and used by the control system 118 to determine the acceleration of the sensor 102.

Determining the distance D4 is achieved through monitoring of capacitance. The control system 118 determines the position of the droplet 110X(2) at the distance D4 by measuring the change of capacitance, for example between the first electrode 132 (6,2) and the second electrode 134. The control system 118 may also determine whether the droplet 110X(2) is stationary at the distance D4 by determining whether the capacitance measured between the first electrode 132(6,2) and the second electrode 134 meets a predetermined guideline. The predetermined guideline may be, for example, that the capacitance associated with the first electrode 132(6,2) remains within a predetermined capacitance range for a threshold time. The threshold time can be for example, in a range from one-hundred (100) to three-hundred (300) milliseconds. When the predetermined guideline is satisfied, then the control system 118 may use the positional information of the distance D4 to determine the acceleration due to the external force F2.

Subsequent determinations of acceleration may be accomplished by returning the droplet 110X(2) to the quiescent point 126(2). In this regard, FIG. 1D is a side sectional view of the droplet 110X(2) within the passageway 112X(2) of FIG. 1C, depicting the droplet 110X(2) returned to the quiescent point 126(2) by the control system 118. The control system 118 may orchestrate control signals to be sent to the first electrodes 132(1,2)-132(NX,2) to return the droplet 110X(2) to the quiescent point 126(2) based on an electrowetting force F4. Once the droplet 110(2) is returned to the quiescent point 126(2), then the electrowetting force F4 may be removed to create the same situation as in FIG. 1B discussed above. In this manner, subsequent determinations of acceleration may occur as the droplet 110X(2) is positioned to move again based on the application of a different external force F2. This cycle may repeat according to computer based instructions available to the control system 118.

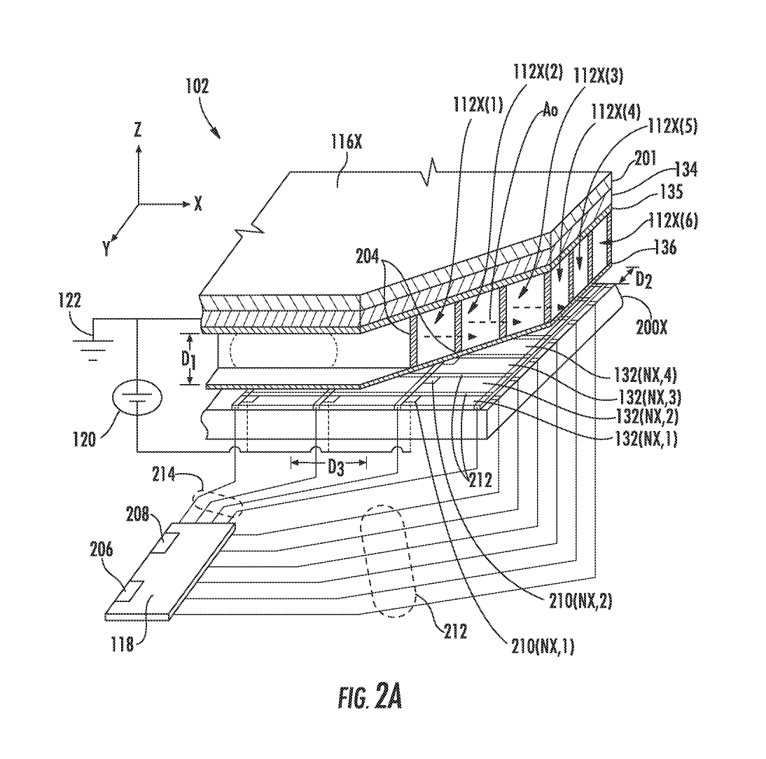

Now that a brief discussion of the operation of the subassembly 116X of the sensor 102 has been provided, details of the features of the subassembly 116X and the control system 118 are now discussed. In this regard, FIG. 2A is a top perspective sectional view of the subassembly 116X. The subassembly 116X includes a substrate 200X upon which the passageways 112X(1)-112X(N2) may be formed from a first hydrophobic layer 136, a second hydrophobic layer 135, and spacers 204. The first hydrophobic layer 136, the second hydrophobic layer 135, and the spacers 204 may fabricated to be supported (directly or indirectly) by the substrate 200X using conventional microlithography and nanotechnology processes as may be used in semiconductor and flat screen display manufacturing. The substrate 200X may comprise, for example, include silicon, glass, and/or quartz. Each of the passageways 112X(1)-112X(N2) are configured to guide the respective droplets 110X(1)-110X(N2) therein along the respective longitudinal axes A0 of the passageways 112X(1)-112X(N2). The passageways 112X(1)-112X(N2) are also configured to keep the droplets 110X(1)-110X(N2) apart. The spacers 204 may also block opposite ends of each of the passageways 112X(1)-112X(N2) at the first end 124A and the second end 124B to prevent the respective droplets 110X(1)-110X(N2) from escaping the passageways 112X(1)-112(N2). The first hydrophobic layer 136 and the second hydrophobic layer 135 enable efficient movement of the droplet 110X(2) along the longitudinal axis A0 by modifying wetting forces. The first hydrophobic layer 136 and the second hydrophobic layer 135, and the spacers 204 may comprise, for example, polytetrafluoroethylene (PTFE), phased-separated spinodal glass powder, ceramic particles, diatomaceous earth, fluorinated organic compounds, silicones, siloxanes, and sol-gel materials including metal oxides. The ceramic particles may, for example, include nanoparticles. The ceramic particles may also include at least one of, for example, aluminum oxide and zinc oxide. The hydrophobic coating may have an effective contact angle at least ninety (90) degrees within the quiescent points 126(1)-126(N2). In this manner, the droplets 110X(1)-110(N2) may relatively easily move through the passageways 112X(1)-112X(N2) in response to the external force F2.

The passageways 112X(1)-112X(N2) are disposed between the first electrodes 132(1,1)-132(NX,N2) and a second electrode 134 which, as discussed in more detail below, enable movement and sensing of the position of respective droplets within the passageways 112X(1)-112X(N2). The height D1 of each of the passageways 112X(1)-112X(N2) may be in a range from 150 microns to 750 microns, and the width D2 of each of the passageways 112X(1)-112X(N2) may in a range from 25 microns to 1.5 millimeters. The decreasing the height D1 and increasing the width D2 increases the capacitance between the respective ones of the first electrodes 132(1,1)-132(NX,N2) and the second electrode 134 to enable higher sensitivity to the position of the droplets 110X(1)-110X(N2). A dielectric layer 201 may be disposed adjacent to the second hydrophobic layer 135 to provide protection against electrical cross-talk and other electrical interference from the electronic device 100.

It is noted that the centers of adjacent ones of the first electrodes 132(1,1)-132(NX,N2) may be separated by a distance D3 along respective ones of the longitudinal axes A0. The distance D3 may be in a range from 150 microns to 1.2 millimeters and may be adjusted according to the requirements of the sensor 102. Each of the droplets 110X(1)-110X(N2) have a sufficient size to span the centers of adjacent ones of the first electrodes 132(1,1)-132(NX,N2) along the longitudinal axes A0, and also to fill the cross section of the respective ones of the passageways 112X(1)-112X(N2) orthogonal to the respective longitudinal axis A0 during operation of the sensor 102. Accordingly, each of the droplets 110X(1)-110X(N2) may abut against the spacers 204, the first hydrophobic layer 136, and the second hydrophobic layer 135 during operation. The droplets 110X(1)-110X(N2) may comprise a fluid comprising ions or polar molecules, for example, water. In this manner, the droplets may be guided by the passageways 112X(1)-112X(N2) along the longitudinal axes A0 using the electrowetting force F4.

The droplets 110X(1)-110X(N2) can be located and moved by the control system 118 using the first electrodes 132(1,1)-132(NX,N2) and second electrode 134. The control system 118 comprises a computer processor 206 and a memory device 208. The computer processor 206 may execute processor instructions needed to determine the positional information of the droplets 110X(1)-110X(N2) within the respective passageways 112X(1)-112X(N) and determine positional information of the droplets 110X(1)-110X(N2) as discussed later. The memory device 208 may be a dynamic random access memory (DRAM) to store the processor instructions to operate the sensor 102 and to enable retrieval of these processor instructions by the computer processor 206.

FIG. 2B is a top view of one the at least one substrate of FIG. 1A prior to forming the first hydrophobic layer 136 therein and depicting an exemplary array of first electrodes 132(1,1)-132(NX,N2) whose voltage potentials can be applied by instructions of the control system 118. By applying the voltage potential at respective ones of the first electrodes 132(1,1)-132(NX,N2), a localized electric field may be formed between the second electrode 134 and the respective ones of the first electrodes 132(1,1)-132(NX,N2). The localized electric field may move the droplets 110X(1)-110X(N2) within the passageways 112X(1)-112X(N2). In order to apply a voltage potential at respective ones of the first electrodes 132(1,1)-132(NX,N2), each of the first electrodes 132(1,1)-132(NX,N2) is electrically connected to respective ones of a plurality of thin film transistors 210(1,1)-210(NX,N2). The control system 118 provides electrical signals to the respective ones of the thin film transistors 210(1,1)-210(NX,N2) through the first command lines 212 and the second command lines 214 to enable the respective ones of the thin film transistors 210(1,1)-210(NX,N2) to apply a voltage potential to the respective ones of the first electrodes 132(1,1)-132(NX,N2). For example, the bases (or gates) of the thin film transistors 210(1,1)-210(NX,N2) may be electrically connected to the first and the second command lines 212, 214 through “AND” digital logic gates (not shown). The control system 118 may orchestrate a voltage potential to be applied to one of the first electrodes 132(1,1)-132(NX,N2) by sending electrical signals to respective ones of the first and the second command lines 212, 214 which intersect at one of the thin film transistors 210(1,1)-210(NX,N2) associated with the one of the first electrodes 132(1,1)-132(NX,N2) of interest. The control system 118 may also change the electrical signal sent through the first and the second command lines 212, 214 to the respective ones of the thin film transistors 210(1,1)-210(NX,N2) to decrease the voltage potential applied to the respective ones of the first electrodes 132(1,1)-132(NX,N2), for example, to be the same or substantially similar to the voltage potential of the second electrode 134. In this manner, the applied voltage potential applied to the respective ones of the first electrodes 132(1,1)-132(NX,N2) may be changed by the control system 118 to change the electric field that is applied to the passageways 112X(1)-112X(N2) to move the droplets 110X(1)-110X(N2).

The control system 118 instructs the voltage potentials to be applied to the first electrodes 132(1,1)-132(NX,N2) and relies on the electrowetting force F4 to return the droplets 110X(1)-110X(N2) to the quiescent points 126(1)-126(N2) for subsequent acceleration determinations. FIG. 3A is a side sectional schematic view of the droplet 110X(2) supported by the first hydrophobic layer 136 with the spacers 204 and second hydrophobic layer 135 removed. The second electrode 134 is replaced by a test electrode 300 for simplicity in FIG. 3A. An electric field 302 is depicted as being applied to the droplet 110X(2) by a voltage potential difference V1 between the first electrodes 132(4,2), 132(5,2) and the test electrode 300. The voltage potential difference V1 may be provided by the power supply 120. The electric field 302 changes the droplet 110X(2) from a shape 304A having a contact angle theta_0 (θ₀) with the first hydrophobic layer 136, to a shape 304B having a contact angle theta_v (θᵥ) with the first hydrophobic layer 136. The shape 304A is primarily determined by the surface tension of the droplet the absence of the electric field 302. The contact angle of the droplet 110X(2) transforms to the contact angle theta_v (θᵥ) upon application of the voltage potential V1 to the first electrodes 132(4,2), 132(5,2) causing the electric field 302.

The first hydrophobic layer 136 is a dielectric and an electrical charge builds up at the surface 306A of the first hydrophobic layer 136 which is disposed opposite the surface 306B facing the electrode 132. The dipoles and/or ions of the droplet 110X(2) having electrical charges attracted to the voltage potential applied to the electrode 132 move closer to the surface 306A of the first hydrophobic layer 136 and cause a decrease in the interfacial tension between the droplet and the surface 306A. The decrease in the interfacial tension increases the contact angle to theta_v (θᵥ) and when asymmetrically directed can move the droplet 110X(2). However, when exposed to a symmetric electric field, increases of the contact angle to theta_v (θᵥ) on opposite sides of the droplet results in a net zero movement of the droplet 110X(2) as the center remains stationary and the droplet 110X(2) “flattens out” into the shape 304B as depicted in FIG. 3A. However, when the droplet straddles more than one of the first electrodes 132(1,2)-132(NX,2) having different voltage potentials and thereby providing an asymmetric electric field to the droplet 110X(2), then the center of the droplet 110X(2) moves or is propelled along the first hydrophobic layer 136.

As an example, of the droplet 110X(2) being moved, FIG. 3B is a side sectional schematic view of the droplet of FIG. 1B being propelled along the center axis A0 of the passageway 112X(2) and the first hydrophobic layer 136 of the subassembly 116X of the sensor 102 of FIG. 1A. The control system 118 applies a voltage potential merely to the first electrode 132(4,2) and the droplet 110X(2) is propelled by an electric field 302 which is asymmetric relative to the droplet 110X(2). The asymmetry in the application of the electric field 302 results in the lower value of the contact angle of theta_v (θᵥ) forming adjacent to the electrode 132(4,2) but the contact angle theta_0 remains adjacent to the electrode 132(6,2). The asymmetrical application of the electric field 302 results in the electrowetting force F4 moving the droplet along the longitudinal axis A0 of the passageway 112X(2) and parallel to the first hydrophobic layer 136. The control system 118 may apply voltages to various ones of the first electrodes 132(1,2)-132(N2,2) to enable the droplet 110X(2) to be moved along the passageway 112X(2) to the quiescent point 126(2). In this manner, the droplet 110X(2) may be moved by the control system 118.

Identifying which of the first electrodes 132(1,1)-132(N2,NX) to apply voltage potential depends on the location of the droplets 110X(1)-110X(N2) within the passageways 112X(1)-112X(N2). Controlling the movement of the droplet includes applying the voltage potential to the one or more of the first electrodes 132(1,1)-132(N2,NX) adjacent to the contact angle nearest the desired direction of travel. In order to apply the voltage potential to appropriate ones of the electrodes 132(1)-132(N2) consistent with desired movement of the droplets 110X(1)-110X(N2), the control system 118 identifies locations of the droplets 110X(1)-110X(N2) within the passageways 112X(1)-112X(N2). The control system 118 determines the locations by measuring capacitance within the passageways 112X(1)-112X(N2) based on electrical signals from the plurality of first electrodes 132(1,1)-132(N2,NX) and the second electrode 134. The first hydrophobic layer 136 having dielectric characteristics in this example acts as a capacitor and the presence of one of the droplets 110X(1)-110X(N2) adjacent to one of the first electrodes 132(1,1)-132(N2,NX) changes the capacitance of the first hydrophobic layer 136 which can be detected by the control system 118. Once the capacitance associated with the first electrodes 132(1,1)-132(N2,NX) adjacent to the droplet location is identified along the passageways 112X(1)-112X(N2), then the voltage may be applied to the appropriate ones of the electrodes 132(1)-132(N2) to move the droplets 110X(1)-110X(N2) to the desired location.

When moving the droplets 110X(1)-110X(N2), the wetting force F1 between the droplets 110X(1)-110X(N2) and the first hydrophobic layer 136 will be overcome to facilitate movement of the droplets 110X(1)-110X(N2). The first hydrophobic layer 136 decreases wetting force F1 by a hydrophobicity characteristic 308. The greater the hydrophobicity characteristic 308, the lower the wetting force F1 opposing the electrowetting force F4 applied to the droplets 110X(1)-110X(N2) by using the first electrodes 132(1)-132(N2) and the second electrode 134. The hydrophobicity characteristic 308 may be formed by a material composition of the first hydrophobic layer 136 or by microscale or nanoscale protrusions added to the surface 306A of the first hydrophobic layer 136. Generally higher occurrences of microscale and nanoscale protrusions at the surface 306A of the first hydrophobic layer 136, the higher the hydrophobicity characteristic 308 (FIG. 3C). For example, as shown in FIG. 3B microscale protrusions 310 and nanoscale protrusions 312 may be formed in the surface 306A of the first hydrophobic layer 136 to provide the hydrophobicity characteristic 308. The density of the microscale protrusions 310 and nanoscale protrusions 312 along the passageway 112X(2) can be predetermined to provide a variable hydrophobicity characteristic 308 along the passageway 112X(2). For example, FIG. 3B depicts microscale protrusions 310 a distance D5 apart in a quiescent point 126(2) of the passageway 112X(2). The nanoscale protrusions 312 may extend from the microscale protrusions 310 at the quiescent point 126(2) to further increase hydrophobicity within the quiescent point 126(2) to provide relatively easy movement of the droplet 110X(2) at the quiescent point 126(2). In contrast, microscale protrusions 310 further away from the quiescent point 126(2) as shown in FIG. 3B may locate the microscale protrusions 310 a distance D6 apart, wherein the distance D6 is greater than the distance D5. This greater distance may decrease hydrophobicity further away from the quiescent point 126(2) and thereby increase the wetting force F1 outside of the quiescent point 126(2). The microscale protrusions 310 may omit the nanoscale protrusions 312 further away from the quiescent point 126(2) to further decrease the hydrophobicity characteristic 308 away from the quiescent point 126(2).

In this regard, FIG. 3C is a chart depicting a hydrophobicity characteristic 308 labeled as theta (θ) of the first hydrophobic layer 136 relative to the quiescent point 126(2) of the sensor depicted in FIG. 3B. The hydrophobicity characteristic 308 decreases linearly from the quiescent point 126(2), but it is recognized that the hydrophobicity characteristic 308 may also decrease in a curvilinear relationship. In this manner, the resistance of the wetting force F1 to the movement of the droplet 110X(2) can be customized at values of the distance D4 further away from the quiescent point 126(2) to result in a longer or shorter distance D4 (FIG. 1C) to be associated with respective associated values of the external force F2.

Now that the subassembly 116X of the sensor 102 has been introduced, an exemplary method 400 for operating a sensor 102 is now disclosed. The method 400 will be discussed using the terminology developed above and operations 402a through 402e depicted in the flowchart provided in FIG. 4.

In this regard, the method 400 includes moving the droplet 110X(2) to the quiescent point 126(2) within the passageway 112X(2) of the sensor 102 using the electrowetting force F4 as directed by the control system 118 (operation 402a of FIG. 4). The method 400 includes moving, in response to the external force F2, the droplet 110X(2) to the displacement position 128 within the passageway 112X(2) while the droplet 110X(2) remains in contact with the first hydrophobic layer 136 (operation 402b of FIG. 4). The method 400 also includes determining, using the control system 118, positional information of the droplet 110X(2) at the displacement position 128 based on electrical signals from the plurality of first electrodes 132(1,2)-132(NX,2) disposed along the passageway 112X(2) and a second electrode 134 (operation 402c of FIG. 4). The method 400 may include determining an acceleration of the sensor 102 along the longitudinal axis A0 based on the positional information of the droplet 110X(2) at the displacement position 128 (operation 402d of FIG. 4). Upon determining the acceleration, the droplet 110X(2) may be returned to the quiescent point 126(2) using the electrowetting force F4. In this manner, the acceleration applied to the sensor 102 by the external force F4 may be determined.

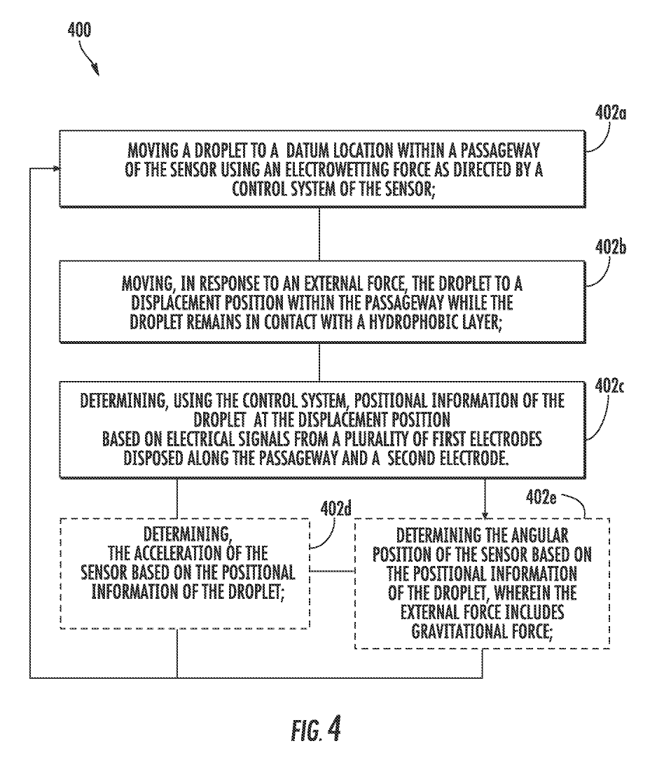

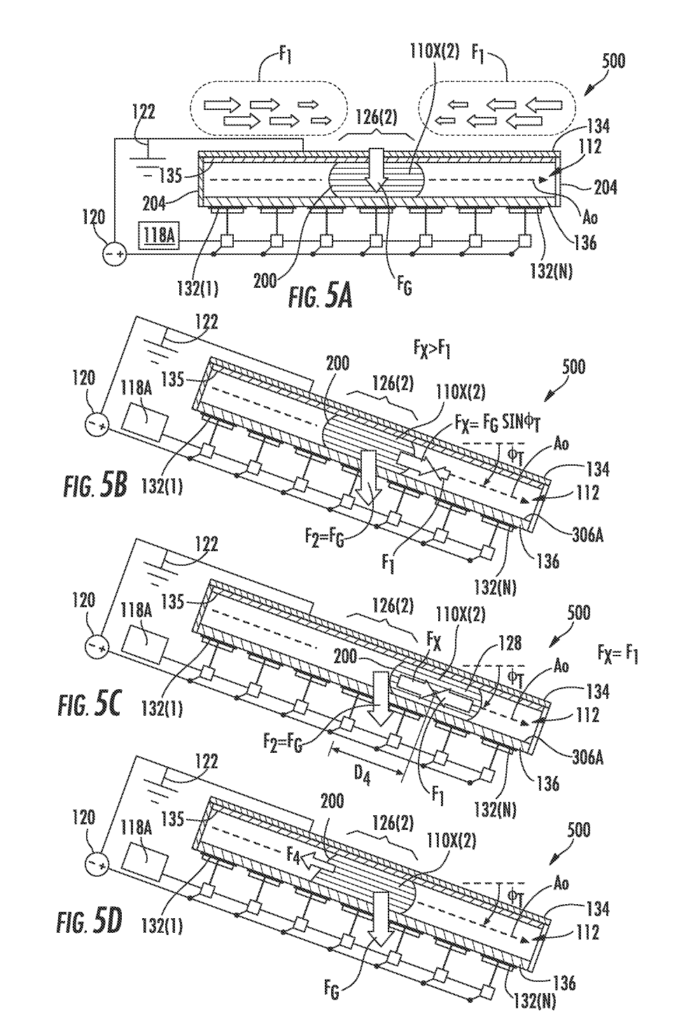

Next, a sensor 500 is disclosed to measure tilt and is another embodiment of the sensor 102 of FIG. 1A. The sensor 500 is similar to the sensor 102 of FIG. 1A and so mainly the differences are now discusses in the interest of clarity and conciseness. In this regard, FIG. 5A is a side sectional view of an exemplary passageway 112 of the sensor 500 illustrating a droplet 110 disposed at a quiescent point 126 and the control system 118A configured to determine positional information of the droplet 110 based on electrical signals from a plurality of first electrodes 132(1)-132(N) and the second electrode 134 as a gravitational force FG is applied to the droplet 110. The passageway 112 is disposed in a horizontal position in FIG. 5A, so the droplet 110 remains static at the quiescent point 126. The first hydrophobic layer 136 includes the hydrophobicity characteristic 308 providing increasing wetting force F1 away from the quiescent point 126. In this manner, the sensor 500 may determine the angular position of the electronic device 100.

FIG. 5B is a side sectional view of the droplet 110 with the sensor 500 of FIG. 5A tilted at the angular position phi_T (φT) to create a component force Fx of the gravitational force FG applied to the droplet 110 and parallel to the hydrophobic surface 306A of the first hydrophobic layer 136. The component force Fx is calculated with a trigonometric relationship, FX=FG*sin φT, wherein FG is the gravitational force applied to the droplet 110 and phi_T (φT) is the angular position measure from horizontal. As the component force FX may be initially greater than the wetting force F1, the droplet 110 initially moves along the longitudinal axis Ao of the passageway 112. In this manner, the external force F2 may include the gravitational force FG.

FIG. 5C is a side sectional view of the droplet 110 and the sensor 500 of FIG. 5B depicting the droplet 110 in a static position at the displacement position 128 and a distance D4 away from the quiescent point 126. It is noted that the distance D4 may or may not be the same distance D4 shown in FIG. 1C. The droplet 110 remains in the static position as long as the wetting force F1 counteracts (or fully opposed) the component force Fx. The control system 118A detects the positional information of the droplet 110 at the displacement position 128 and may determine angular position based on the displacement position 128. In one example, the control system 118 may use look-up tables, to determine the angular position phi_T associated with the displacement position 128. In this manner, the sensor 500 may determine angular position (or tilt) of the sensor 500.

FIG. 5D is a side sectional view of the droplet 110 and the sensor 500 of FIG. 5C depicting returning the droplet 110 to the quiescent point 126 from the displacement position 128 by using the electrowetting force F4 resulting from the asymmetric electric field applied to the droplet 110 by the first electrodes 132(1)-132(N) and the second electrode 134 as instructed by the control system 118A. In this manner, the droplet 110 becomes available to determine another angular position of the sensor 500.

It is noted that the control system 118 of the sensor 102 of FIG. 1B may incorporate the features of the control system 118A of the sensor 500 of FIG. 5D. In this regard, the method 400 in FIG. 4 may include determining the angular position φT of the sensor 500 based on the positional information of the droplet 110, wherein the external force F2 includes the gravitational force FG (operation 402e of FIG. 4).

It is also noted that the acceleration and angular tilt measurements may be determined for droplets disposed in passageways that are orientated in three-dimensions (3-D) and vector calculations may be used to determine three-dimensional acceleration and angular position with respect to three axes X, Y, and Z.

To facilitate understanding, identical reference numerals have been used, where possible, to designate identical elements that are common to the figures. It is contemplated that elements and features of one embodiment may be beneficially incorporated in other embodiments without further recitation.

Many modifications and other embodiments not set forth herein will come to mind to one skilled in the art to which the embodiments pertain having the benefit of the teachings presented in the foregoing descriptions and the associated drawings. Therefore, it is to be understood that the description and claims are not to be limited to the specific embodiments disclosed and that modifications and other embodiments are intended to be included within the scope of the appended claims. It is intended that the embodiments cover the modifications and variations of the embodiments provided they come within the scope of the appended claims and their equivalents. Although specific terms are employed herein, they are used in a generic and descriptive sense only and not for purposes of limitation.

While the foregoing is directed to embodiments of the present disclosure, other and further embodiments of the disclosure may be devised without departing from the basic scope thereof, and the scope thereof is determined by the claims that follow.

What is claimed is:

1. A sensor, comprising:
a substrate including a plurality of first electrodes arranged along a longitudinal axis of a passageway;
a hydrophobic layer forming at least a portion of the passageway;
a second electrode supported by the substrate, wherein the passageway is disposed between the second electrode and the plurality of first electrodes;
a droplet disposed within the passageway, wherein the droplet moves to a displacement position within the passageway in response to an external force; and
a control system electrically coupled to the plurality of first electrodes and the second electrode, and the control system is configured to determine positional information of the droplet at the displacement position.

2. The sensor of claim 1, wherein the control system includes a power source configured to induce an electric field between predetermined ones of the plurality of first electrodes and the second electrode to return the droplet to the quiescent point from the displacement position.

3. The sensor of claim 1, wherein the control system is configured to determine capacitance between predetermined ones of the plurality of first electrodes and the second electrode.

4. The sensor of claim 1, wherein the hydrophobic layer includes a hydrophobicity characteristic which has a higher hydrophobicity at the quiescent point than at the displacement position.

5. The sensor of claim 4, wherein the droplet remains disposed at the quiescent point when the longitudinal axis is in a horizontal and static position.

6. The sensor of claim 4, wherein the external force includes gravity and the droplet is configured to move to a predetermined position along the longitudinal axis according to a tilt position of the longitudinal axis, and the control system is configured to determine the tilt position of the longitudinal axis based on the positional information of the droplet.

7. The sensor of claim 1, wherein the control system is configured to operate according to cycles, wherein the control system is configured to locate the droplet to the location at the beginning of each cycle, and the control system is configured to determine positional information is during the cycle, wherein the positional information during the cycle includes identifying at least one predetermined position of the droplet along the longitudinal axis during the cycle after movement of the droplet from the quiescent point.

8. The sensor of claim 7, wherein a duration of the cycles are in a range from one-hundred to five-hundred milliseconds.

9. The sensor of claim 8, wherein the control system is configured to determine acceleration of the substrate based on the positional information determined during the cycle.

10. The sensor of claim 1, wherein each of the plurality of first electrodes and the second electrode form a plurality of thin-film transistors.

11. A method for operating a sensor, comprising:
moving a droplet to a quiescent point within a passageway of the sensor using an electrowetting force as directed by a control system of the sensor;
moving, in response to an external force, the droplet to a displacement position within the passageway while the droplet remains in contact with a hydrophobic layer; and
determining, using the control system, positional information of the droplet at the displacement position based on electrical signals from a plurality of first electrodes disposed along the passageway and a second electrode.

12. The method of claim 11, wherein the determining the positional information includes detecting changes in the capacitance between predetermined ones of the plurality of first electrodes and the second electrode.

13. The method of claim 12, further comprising returning the droplet to the quiescent point from the displacement position, with a power supply of the control system, by inducing an electric field between predetermined ones of the plurality of first electrodes and the second electrode to move the droplet using the electrowetting force to the quiescent point.

14. The method of claim 13, further comprising operating the control system according to cycles, wherein the droplet is returned to the quiescent point at the beginning of each cycle, and the positional information during the cycle, and the positional information is determined by the control system during the cycle by identifying at least one predetermined position of the droplet along the longitudinal axis during the cycle after movement of the droplet from the quiescent point.

15. The method of claim 11, further comprising determining an acceleration of the sensor along the longitudinal axis based on the positional information of the droplet.

16. The method of claim 15, wherein the operating the control system includes beginning new cycles once a cycle time has elapsed, wherein the cycle time is in a range from one-hundred milliseconds to five-hundred milliseconds.

17. The method of claim 11, wherein the moving the droplet to a displacement position includes providing an increased wetting force to the movement of the droplet at the displacement position, wherein a hydrophobicity characteristic of the hydrophobic layer at the displacement position is less than the hydrophobicity characteristic at the quiescent point.

18. The method of claim 11, wherein the moving the droplet to the quiescent point includes forming the electrowetting force with an electric field between various ones of a plurality of first electrodes arranged sequentially along a longitudinal axis of the passageway and a second electrode, wherein the passageway is disposed between the plurality of first electrodes and the second electrode.

19. The method of claim 11, further comprising determining the tilt position of the longitudinal axis based on the positional information of the droplet, wherein the external force includes gravity.

20. An accelerometer, comprising:
a substrate including a plurality of first electrodes arranged sequentially along a longitudinal axis extending from a first end to a second end opposite the first end, wherein centers of adjacent ones of the plurality of first electrodes along the longitudinal axes are separated by a distance in a range from 150 microns to 1.2 millimeters;
a hydrophobic layer forming at least a portion of the passageway;
a second electrode supported by the substrate, wherein the passageway is disposed between the second electrode and the plurality of first electrodes;
a droplet disposed within the passageway, wherein the droplet moves within the passageway to a displacement position in response to an external force; and
a control system electrically coupled to the plurality of first electrodes and the second electrode, and the control system is configured to apply an electric field between the plurality of first electrodes and the second electrode to move the droplet to a quiescent point within the passageway using an electrowetting force at the beginning of each of a plurality of cycles, the control system is further configured to determine positional information of the droplet at the displacement position during each of the plurality of cycles and to determine an acceleration of the sensor due to the external force for each of the plurality of cycles.
